(19) United States
(12) Patent Application Publication
(10) Pub. No.: US 2024/0343629 A1
(43) Pub. Date: Oct. 17, 2024

(54) SILICON MOLD FOR HIGH TEMPERATURE COMPRESSION MOLDING AND PREPARATION METHOD THEREOF

(71) Applicants: Shenzhen Technology University, Shenzhen Guangdong (CN); Huatong Optical Technology (Zhejiang) Co., Ltd., Huzhou City (CN)

(72) Inventors: Lihua Li, Shenzhen Guangdong (CN); Ruiying Wang, Shenzhen Guangdong (CN)

(21) Appl. No.: 18/636,709

(22) Filed: Apr. 16, 2024

(30) Foreign Application Priority Data
Apr. 17, 2023 (CN) 202310433351.0

(51) Int. Cl. C03B 11/06; C03B 11/05

(52) U.S. Cl. CPC C03B 11/08; C03B 11/05; C03B 11/06; C03B 11/084; C03B 2215/05

(57) ABSTRACT

The present invention relates to a silicon mold device for production of an optical element in a high temperature environment and a preparation method thereof. The silicon mold device utilized in this invention features a symmetrical structure, ensuring uniform deformation during heating to mitigate eccentricity issues. Additionally, a stepped silicon mold core is employed and secured by applying force through an electrode pressure plate, thereby enhancing overall parallelism. Support columns assist in the closure and alignment of the upper and lower molds. Each support column can be individually adjusted for parallelism, facilitating the enhancement of precision and reliability in the preparation of optical elements.

### CROSS REFERENCE TO RELATED APPLICATIONS

This application claims priority to China Patent Application No. 202310433351.0, filed Apr. 17, 2023, the disclosure of which is incorporated herein by reference.

### TECHNICAL FIELD

The present invention is within the technical field of precise compression molding and concerns a mold base device for fixing a silicon mold core and its preparation method. Specifically, it relates to a silicon mold device for producing optical elements under high- temperature conditions, along with its preparation method.

### BACKGROUND

Precise compression molding is an advanced manufacturing technology that replicates the surface topography of a mold onto an optical material substrate at high temperatures. It has characteristics such as high precision, efficiency, and cost-effectiveness, making it particularly adept at producing large-area optical elements with intricate topographies. In recent years, optical glass elements have found widespread application across various sectors including consumer electronics, medical equipment, and military weaponry. Monocrystalline silicon, renowned for its outstanding mechanical properties and chemical stability at high temperatures, has emerged as a popular choice for mold materials in precise compression molding. A specialized mold base is required to secure the silicon mold core. Presently, mold steel is the commonly chosen material for the mold base. The assembly of the silicon mold core and the mold base forms a complex-shaped mold, serving as a precise tool for the manufacturing process. This mold must withstand the bulging force exerted by the blank and meets stringent requirements for structural strength, stiffness, surface hardness, surface roughness, and processing precision. The level of advancement in mold production serves as a key indicator of the machinery manufacturing industry's technological prowess.

However, traditional silicon mold design has the following issues: (1) It overlooks the deformation of the mold base material itself due to thermal expansion. Consequently, the mold base deformation may alter the clamping and centering position of the mold, thereby impacting product precision. (2) It ignores the expansion and deformation of the silicon mold core at high temperatures, leading to eccentricity in the mold core, which in turn affects product precision. (3) The design of dimensional tolerances fails to address the parallelism issue during processing, and subsequent adjustments cannot be made, ultimately compromising product precision.

The Chinese patent publication (CN206644116U) describes a new type of silicon carbide mold comprising a fixed mount and a mold base. The fixed mount consists of a bearing bottom plate, a fixing screw hole, and a limiting groove positioned to the right of the fixing screw hole. The limiting groove is securely connected to the right side of the fixing screw hole, while the upper part of the bearing bottom plate is firmly linked to the mold base. The mold base comprises an upper template, a lower template, cylinder columns situated below the upper template, a mold groove, a bushing surrounding the mold groove, and a through hole within the cylinder column. The outer surface of the cylinder column is firmly connected to the mold groove, with the bushing fixedly attached to the lower template. Additionally, a pressing piece is positioned above the lower template.

However, existing silicon carbide molds overlook the expansion and deformation of both the mold base and mold core during heating. Additionally, there is a challenge regarding the fixed parallelism of the upper and lower mold connections, which cannot be adjusted.

### SUMMARY

The objective of the present invention is to provide a mold base device for fixing a silicon mold core and a preparation method of the mold base device. Specifically, it pertains to a silicon mold device utilized for fabricating optical elements in high-temperature environments, accompanied by its preparation method. The present invention introduces a silicon mold device and its corresponding preparation method, ensuring overall processing precision and enhancing the adjustability of the silicon mold. This silicon mold is specifically designed for high-temperature compression molding and comprises several components. The mold includes an upper mold base and a lower mold base positioned opposite each other. The upper mold base is fixed onto the upper mount, while the silicon mold core is secured onto the lower mount and supported by it. The upper mount, with a larger area than the upper mold base, is supported by upper mount support columns situated on its edge, stabilizing the entire structure of the silicon mold, and facilitating mold closing and coining of upper and lower molds. The silicon mold core is centrally located on the lower mold base and held in place by the electrode pressing plate. Around the upper surface of the lower mold base, larger positioning holes are provided, each with a detection hole on its edge. Spring push blocks, pre-press blocks, and quartz strips are positioned around the silicon mold core, with the spring push blocks symmetrically placed outside the silicon mold core and connected to the lower mold base by springs. This arrangement allows for adjusting the force that fixes the silicon mold core by altering the movement of the spring push blocks. The quartz strips, situated below the spring push blocks, serve to limit the specific position of the silicon mold core during fixation. In one aspect of the silicon mold of the present invention, the upper mount support columns are four in number, which are located at four corners of the rectangular upper mount. Each of the support columns is fixedly joined with the upper mount and is used to adjust a parallelism between the upper mount and the lower mount respectively. The upper mount is maintained parallel to the lower mount. Silicon in the form of steps is employed as the silicon mold core, which is fixed by the electrode pressing plate.

In another aspect of the silicon mold in the present invention, four positioning holes are arranged on either the rectangular or circular surface of the lower mold base. The tolerance between these positioning holes and the outer circumference of the lower mold base is constrained to within 1 micron. Furthermore, the parallelism between the central cavity of the entire lower mold base and its lower surface, as well as between its upper and lower surfaces, is maintained within 1 micron. These measures ensure that the final precision of dimensional tolerance, tolerance of form and position reaches 1 micron.

In another aspect of the silicon mold in the present invention involves utilizing the detection holes positioned on the edges of the positioning holes. These detection holes serve to monitor the deformation state of both the upper mold base and the lower mold base after undergoing multiple high-temperature heating cycles.

In another aspect of the silicon mold of the present invention, the spring push blocks are two or four in number. Through the movement of the spring push blocks, the adjustable range of the size of the silicon mold core is increased. The force that fixes the silicon mold core is changed in magnitude so as to disassemble and assemble the silicon mold core. The pre-press blocks are provided correspondingly above the spring push blocks. The pre-press blocks above the spring push blocks limit the movement direction of the spring push blocks, to ensure the stability of the silicon mold core. The quartz strips are high-precision quartz strips, which limit the specific position when fixing the silicon mold core.

In another aspect of the silicon mold in the present invention involves the utilization of two or four spring push blocks. These blocks facilitate the adjustment of the silicon mold core's size by enabling movement. By adjusting the force used to secure the silicon mold core, it becomes easier to disassemble and assemble the mold. Correspondingly positioned above the spring push blocks are pre-press blocks. These blocks restrict the movement direction of the spring push blocks, ensuring the stability of the silicon mold core during operation. Furthermore, the silicon mold incorporates high-precision quartz strips, which play a critical role in limiting the specific position of the silicon mold core during fixation.

The present invention discloses a method for preparing a silicon mold for high- temperature compression molding. The method involves the following steps: Providing a silicon mold device consisting of an upper mold base and a lower mold base. An upper mount and a lower mount are fixed on the upper and lower mold bases, respectively. These mounts hold an upper silicon mold core and a lower silicon mold core, positioned opposite to each other; Placing spring push blocks symmetrically outside the upper and lower silicon mold cores. These push blocks are connected to the upper and lower mold bases by springs, allowing them to adjust their movement and thereby alter the force that fixes the silicon mold cores; Placing optical glass raw materials for lens preparation into the silicon mold device, then closing the mold device; Heating the silicon mold device from room temperature (approximately 20 degrees Celsius) to about 700 degrees Celsius. This heating process takes approximately 90 seconds to complete the compression molding of the lens; Cooling the molded lens.

In one aspect of the preparation method provided by the present invention, pre-press blocks (11) are placed beneath the spring push blocks (10). These pre-press blocks (11) serve to constrain the movement of the spring push blocks (10) in a specific direction.

The present invention provides a mold base device designed to secure a silicon mold core. Utilizing a symmetrical structure, this device ensures uniform deformation during heating, thereby mitigating eccentricity issues. Furthermore, supporting columns are incorporated to enable the closing and coining of the upper and lower molds. Each support column can be adjusted for parallelism as needed. Moreover, the mold base device of the present invention features spring push blocks, pre-press blocks, and quartz strips, which serve to restrict the specific positioning during the fixation of the silicon mold core. Additionally, detection holes within the mold base device facilitate the monitoring of mold base deformation following repeated high-temperature heating cycles.

### DESCRIPTION OF THE DRAWINGS

To describe the technical solutions in the embodiments of the present invention, the necessary drawings are briefly introduced below. It should be noted that the drawings provided herein represent only a selection of examples of the present invention. Skilled individuals in the field can generate additional drawings based on these examples without necessitating significant creative effort.

FIG. 1 is a schematic structural diagram of a silicon mold device of the present invention.

FIG. 2 is a schematic structural diagram of a silicon mold core and a lower mold base within a silicon mold device of the present invention.

FIG. 3 is a flow chart detailing the preparation process of a silicon mold device of the present invention.

### DETAILED DESCRIPTION

Specific embodiments of the present invention are now described with reference to the accompanying drawings. It should be noted that this invention may be embodied in various forms, and thus, it should not be interpreted as limited to the embodiments presented herein. These embodiments are provided to ensure thoroughness and completeness in disclosing the invention's scope to those skilled in the art. The language used in the detailed description of the illustrated embodiments should not constrain the scope of protection afforded by the present invention.

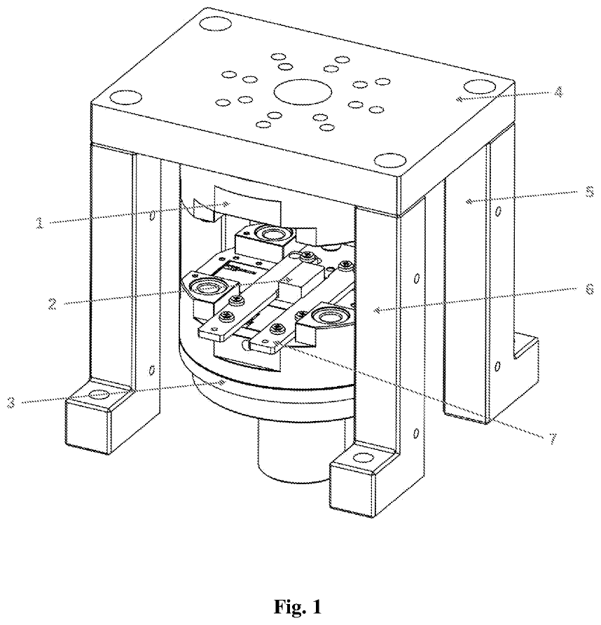

FIG. 1 depicts a schematic structural diagram of the silicon mold device according to the present invention. The silicon mold device comprises several components: an upper mold base 1, a silicon mold core 2, a lower mount 3, an upper mount 4, upper mount support columns 5, a lower mold base 6, and an electrode pressing plate 7. In one embodiment, both the upper mold base 1 and the lower mold base 6 are constructed from S136 mold steel. The entire silicon mold device is subjected to a heating temperature of approximately 700 degrees Celsius. Due to the use of mold steel for the upper and lower mold bases, any deformation caused by heating is negligible. The upper mold base 1 and the lower mold base 6 are positioned opposite each other. The upper mold base 1 is affixed to the upper mount 4, while the silicon mold core 2 is attached to the lower mount 3 and supported by it. Additionally, another silicon mold core (not shown in the figure) is fixed onto the upper mold base 1, opposite to the lower mold base 6. The silicon mold core 2 can take various shapes, such as cubic, cuboid, or stepped shapes. In one embodiment, the area of the upper mount 4 may exceed that of the upper mold base, and it is supported by the upper mount support columns 5 positioned at the edges of the upper mount 4. This arrangement stabilizes the structure of the entire silicon mold and facilitates the closing and coining of the upper and lower molds. In another embodiment, there may be four support columns, each positioned at a corner of the rectangular upper mount 4. These support columns can be used to adjust the parallelism between the upper and lower molds, thereby enhancing the overall adjustability of the silicon mold. The silicon mold core 2, in the form of steps, is secured by the electrode pressing plate 7. To address the issue of expansion and deformation of the upper and lower mold bases at high temperatures, corresponding symmetrical structures are provided at symmetrical positions. This ensures that both mold bases expand and deform uniformly when heated. Therefore, the adoption of a symmetrical structure, particularly one symmetrical with respect to the center of a circle, helps alleviate eccentricity issues and ensures effective centering when the molds are closed.

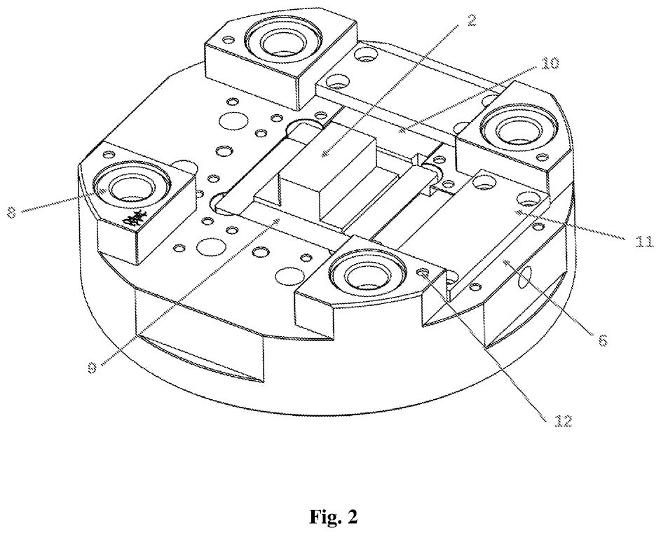

FIG. 2 is a schematic structural diagram of a silicon mold core and a lower mold base in a silicon mold device of the present invention. The silicon mold core 2 is centrally positioned within the lower mold base 6 and is securely affixed by the electrode pressing plate 7. Around the upper surface of the lower mold base 6, larger positioning holes 8 are provided. In one embodiment, these holes are arranged in rectangular, circular, or similar configurations. Each positioning hole 8 is accompanied by a detection hole 12 located at its edge. Surrounding the silicon mold core 2, several components are provided to ensure precise positioning and stability. Spring push blocks 10, pre-press blocks 11, and quartz strips 9 are positioned around the silicon mold core. The spring push blocks 10, which may number two or four in various embodiments, are symmetrically placed outside the silicon mold core and connected to the lower mold base via springs. This arrangement enables adjustable movement of the spring push blocks, thereby facilitating assembly and disassembly of the silicon mold core and altering the fixing force magnitude. High-precision quartz strips 9, positioned below the spring push blocks 10, serve to restrict the specific position of the silicon mold core during fixation. Correspondingly, pre-press blocks 11, numbering two or four in different embodiments, are placed above the spring push blocks to limit their movement direction, ensuring stability of the silicon mold core. To achieve optimal results, precise dimensions of the mold bases are essential. For instance, the tolerance between the positioning holes and the outer circle of a mold base must be within 1 micron. Additionally, the parallelism between the middle pit of the entire lower mold base and its lower surface, as well as between its upper surface and lower surface, should be maintained within 1 micron. This ensures the final precision of dimensional tolerance and form, and position tolerance reaches 1 micron, guaranteeing overall processing precision. Furthermore, detection holes 12 are included at the edges of each positioning hole 8 to facilitate monitoring of the mold base's deformation state after repeated high-temperature heating cycles. This detailed configuration ensures precise positioning and stability of the silicon mold core within the lower mold base, thereby enhancing the efficiency and accuracy of the molding process.

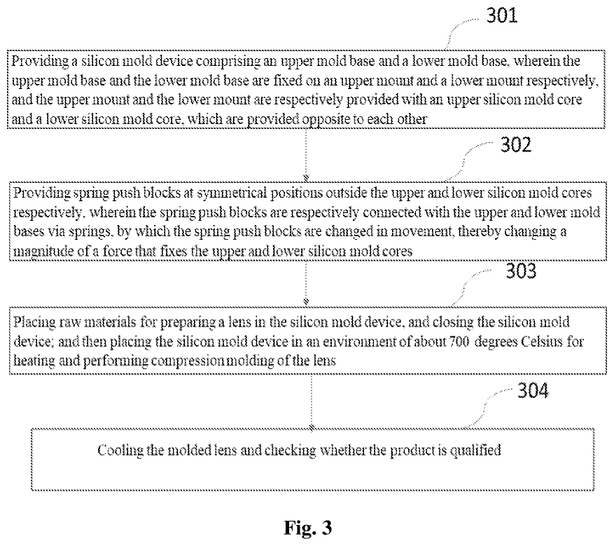

FIG. 3 illustrates the process flow for preparing a silicon mold device according to the present invention. In step 301, a silicon mold device consisting of an upper mold base and a lower mold base is provided. The upper mold base and lower mold base are affixed to an upper mount and a lower mount, respectively. Additionally, an upper silicon mold core and a lower silicon mold core are positioned opposite to each other on the upper and lower mounts. Step 302 involves the placement of spring push blocks at symmetrical positions outside the upper and lower silicon mold cores. These spring push blocks are connected to the upper and lower mold bases via springs, allowing for adjustable movement to alter the fixing force magnitude of the silicon mold cores. Optionally, pre-press blocks may be installed below the spring push blocks to restrict their movement direction. In step 303, optical glass raw materials are placed into the silicon mold device in preparation for lens production. Subsequently, the silicon mold device is closed, and the temperature is raised from room temperature (approximately 20 degrees Celsius) to 700 degrees Celsius over a period of about 90 seconds to facilitate the compression molding of the lens. Finally, in step 304, the molded lens is cooled, and its quality is assessed for qualification. Inspection is conducted under an optical microscope to detect any defects or bubbles. If the product meets the specified quality criteria, it is deemed to be qualified.

The present invention offers a practical solution for designing high-temperature compression molding silicon molds. By employing symmetrical silicon molds, the adverse effects of parallelism errors are effectively minimized to within 2 microns. This results in significantly enhanced dimensional precision and surface shape accuracy, potentially achieving a yield of up to 85%. The mold demonstrates excellent repeatability and reliability, maintaining high product precision even after numerous cycles of high-temperature compression molding and coining operations.

When reference is made herein to “one embodiment”, “an embodiment”, or “one or more embodiments”, it denotes that a specific feature, structure, or characteristic described in connection with the embodiment is included in at least one embodiment of the invention. It is noted that the terms and examples “in one embodiment” herein do not necessarily all refer to the same embodiment. The above description serves to illustrate the technical solutions of the present invention. Modifications and alterations to the described embodiments can be made by persons of ordinary skill in the art without departing from the spirit and scope of the invention. Therefore, the scope of protection of the present invention is defined by the claims. While examples have been provided above, it is acknowledged that other embodiments beyond those described are equally feasible within the disclosed scope of the present invention. The features and steps of the invention may be combined in alternative ways not explicitly mentioned. The scope of the invention is solely determined by the appended claims. Moreover, it is understood by those skilled in the art that all parameters, dimensions, materials, and configurations described herein are for illustrative purposes only, and actual parameters, dimensions, materials, and/or configurations will vary depending on the specific applications for which the teachings of the present invention are intended.

What is claimed:

1. A silicon mold for high-temperature compression molding is characterized by the inclusion of an upper mold base (1), a silicon mold core (2), a lower mount (3), an upper mount (4), upper mount support columns (5), a lower mold base (6), and an electrode pressing plate (7). In this configuration, the upper mold base (1) is positioned opposite to the lower mold base (6). It is affixed to the upper mount (4), while the silicon mold core (2) is fixed onto the lower mount (3) and supported by it. Additionally, the area of the upper mount (4) exceeds that of the upper mold base (1). Supported by upper mount support columns (5) located at the edge of the upper mount (4), this setup stabilizes the structure of the entire silicon mold and facilitates the closing and coining of upper and lower molds;
the silicon mold core (2) is situated centrally on the lower mold base (6) and secured in place by the electrode pressing plate (7). Larger positioning holes (8) encircle the upper surface of the lower mold base (6), with a detection hole (12) positioned on the edge of each positioning hole (8). Surrounding the silicon mold core (2) are spring push blocks (10), pre-press blocks (11), and quartz strips (9). The spring push blocks are symmetrically placed outside the silicon mold core (2);
the spring push blocks (10) are connected to the lower mold base (6) via springs, allowing for their movement to change the force that fixes the silicon mold core (2). Below the spring push blocks (10), quartz strips (9) are positioned. These quartz strips (9) serve to restrict the specific position of the silicon mold core (2) when it is being fixed in place.

2. The silicon mold according to claim 1 feature four upper mount support columns (5), positioned at the four corners of the rectangular upper mount (4). Each support column (5) is firmly attached to the upper mount (4) and serves to adjust the parallelism between the upper mount (4) and the lower mount (3), ensuring that the upper mount (4) remains parallel to the lower mount (3). Additionally, the silicon mold core (2) takes the form of stepped silicon and is secured in place by the electrode pressing plate (7).

3. The silicon mold of claim 1 or claim 2 features four positioning holes (8), positioned on the rectangular or circular surface of the lower mold base (6). The tolerance between the positioning holes (8) and the outer circumference of the lower mold base (6) is restricted to within 1 micron. Furthermore, both the parallelism between the middle pit of the entire lower mold base (6) and its lower surface, and the parallelism between its upper surface and lower surface, are maintained within 1 micron. This ensures that the final precision of dimensional tolerance and tolerance of form and position reaches 1 micron.

4. The silicon mold of claim 3 includes detection holes (12) positioned on the edges of the positioning holes (8). These detection holes (12) serve the purpose of monitoring the deformation state of both the upper mold base (1) and the lower mold base (6) after undergoing multiple cycles of high-temperature heating.

5. The silicon mold of claim 1 or claim 2 may have either two or four spring push blocks (10). These spring push blocks (10) enable an increased adjustable range in the size of the silicon mold core (2) by their movement, allowing for changes in the magnitude of the force that fixes the silicon mold core (2) to facilitate disassembly and assembly. Correspondingly, pre-press blocks (11) are positioned above the spring push blocks (10). These pre-press blocks (11) restrict the movement direction of the spring push blocks (10) to ensure the stability of the silicon mold core (2). Furthermore, the quartz strips (9) employed are high-precision quartz strips, which serve to limit the specific position when fixing the silicon mold core (2).

6. A method for preparing a silicon mold for high-temperature compression molding involves:
providing a silicon mold device entails assembling components comprising an upper mold base (1) and a lower mold base (6). An upper mount (4) and a lower mount (3) are affixed respectively to the upper mold base (1) and the lower mold base (6); additionally, the upper mount and lower mount are equipped with an upper silicon mold core and a lower silicon mold core, situated opposite to each other. Furthermore, spring push blocks (10) are positioned symmetrically outside both the upper and lower silicon mold cores. These spring push blocks (10) are connected to their corresponding upper and lower mold bases (1,6) via springs, facilitating their movement. Consequently, the movement of the spring push blocks (10) alters the force that fixes the upper and lower silicon mold cores;
placing optical glass raw materials for lens preparation into the silicon mold device, followed by closing the mold device. The device is then heated from room temperature (20 degrees Celsius) to approximately 700 degrees Celsius. This heating process typically lasts around 90 seconds, completing the compression molding of the lens; Finally, the molded lens is cooled.

7. In the method as claimed in claim 6, pre-press blocks (11) are positioned beneath the spring push blocks (10). These pre-press blocks (11) function to constrain the movement direction of the spring push blocks (10).
